(19) United States
(12) Patent Application Publication
(10) Pub. No.: US 2010/0153708 A1
(43) Pub. Date: Jun. 17, 2010

(54) Server Assisted Portable Device

(76) Inventor: Lior Eli Malka, Chevy Chase, MD (US)

Correspondence Address: Lior Malka, 8209 Meadowbrook Lane, Chevy Chase, MD, 20815-3001, US

(21) Appl. No.: 12/615,264

(22) Filed: Nov. 10, 2009

Related U.S. Application Data
(60) Provisional application No. 61/201,407, filed on Dec. 11, 2008.

(51) Int. Cl. H04L 29/06; G06F 21/24; G06F 12/00; H04K 1/00; G06F 13/14; H04L 9/00

(52) U.S. Cl. 713/155; 726/26; 711/173; 380/270; 726/30; 710/305; 713/171

(57) ABSTRACT

A method for allowing or disallowing host access to data stored in a portable device is discussed. The method uses a password and network server. Access to the data is allowed if the password is correct and messages received from the server are positive. If the portable device receives a negative message from the server, then access is disallowed, even if the password is correct. In another embodiment of the invention, a password is provided to the portable device; the password is encrypted in the portable device, and sent to the network server. Upon requests for data from the host computer, the portable device encrypts the data and sends the encrypted data to the host computer. A network server receives an encryption of the password from the portable device, and if the password is correct, then the network server sends the decryption key for the data to the host computer.

### CROSS REFERENCE TO RELATED APPLICATIONS

Non-provisional application number: Ser. No. 12/615,264

Filing date: Nov. 10, 2009

Name of applicant: Lior Malka

Title of the invention: Server Assisted Portable Device

Provisional application number: 61/201,407

Filing date: Dec. 11, 2008

Name of applicant: Lior Malka

Title of the invention: Server Assisted Portable Device

### FIELD OF THE INVENTION

The invention generally relates to portable devices and more particularly to using a network server and a password in order to allow or disallow host computer access to data stored in a portable device.

### BACKGROUND OF THE INVENTION

Portable devices, such as USB flash drives and media players, provide a convenient way to carry data. However, the disadvantage of carrying data on a portable device is that the data can be accessed by unauthorized users. A simple approach to preventing unauthorized access to the data on the portable device is to require that a password be provided, and allow access to the data if the password provided to the portable device matches the password stored on the portable device.

Unfortunately, most people do not protect their passwords, or they choose passwords that are easy to guess. Furthermore, portable devices are often left unattended, or they get lost. Hence, in a scenario where an unauthorized user obtains the password as well as the portable device, the unauthorized user can access the data on the portable device indefinitely.

It would therefore be desirable to provide a method for protecting data on portable devices that does not rely only on passwords, and allows, among other things, to remotely disable a lost portable device so that data on the portable device cannot be accessed even if an unauthorized user obtains the password as well as the portable device.

It is known to prevent unauthorized access to a data storage device using a password. For example, U.S. Pat. No. 5,469,564, which was issued to Tempaku Junya on Nov. 21, 1995, discloses a data storage device having the capability of preventing unauthorized access to data stored therein comprising, for example, memory means having a first portion for storing an internal password and a second portion for storing address data indicating the location of said internal password in said first portion.

Similarly, U.S. Pat. No. 6,141,774, which was issued to Karl-Heinz Mattheis on Apr. 17, 1998, teaches an integrated peripheral comprising an associated register, the register comprises a data area containing a password, and is connected to a read/write control unit comprising a comparator which compares the password with data transmitted to the peripheral device during a first access, the read/write control unit generating an enabling signal only if the comparator generates a predefined comparison signal.

U.S. Pat. No. 6,012,146, which was issued to Frank W. Liebenow on Jan. 4, 2000, discloses a device and a method for preventing unauthorized access to data on a hard drive that is movable from one system having an access restrictor which permits access to the data on the hard drive only through use of a password to another system in which the data on the hard drive would have been accessible without providing the password.

U.S. Pat. No. 7,130,978, which was issued to Toshimitsu Kamano et. al. on Oct. 31, 2006, teaches a storage system comprising a control unit for receiving a data write request from a plurality of host computers which configure a plurality of host groups, and at least one storage unit coupled to said control unit, said storage unit has a plurality of storage regions for storing data, wherein said control unit has security information indicating relationships between each of said host groups and each of said storage regions accessible for each of said host groups.

U.S. Pat. No. 7,278,025, issued to Saito et. al. on Oct. 2, 2007, describes an identification card equipped with a processor and a sensor for capturing biometric data. The card transmits data only if the processor confirms that the captured biometric data matches the locally stored biometric data. A related system and method for authenticating a user for an account, wherein the data entry interface is shown as a numerical keypad, is described in U.S. Pat. No. 6,776,332, issued to Allen et. al. on Aug. 17, 2004.

U.S. Pat. Application Publication 2005/0182973, issued to Funahashi et. al. on Jan. 14, 2005, teaches an information storage device equipped with a password input part (for example, a jog dial) for inputting a password to be notified only to the information storage device without outputting it to the external equipment connected to it by way of a predetermined interface. Funahashi et. al. also describe a system for network access comprising a server device; a terminal device connected to the server device by way of a network; and a removable information storage device connected to the terminal device; the information storage device comprising, among other things: a storage area for storing an encryption key; an access permission part; and a one-time password generator for generating a one-time password different from any preceding passwords according to a predetermined algorithm, the password generator using the encryption key stored in the storage area permitted by the access permission part to be accessed and a challenge code transmitted from the server device in response to an access request made by the terminal device to the server device.

### BRIEF SUMMARY OF THE INVENTION

In accordance with the present invention, a method incorporating a password and a network server is provided that enables or disables host computer access to data stored in a portable device registered with the network server. The portable device receives messages from the network server, allowing access to the data if a correct password is provided and all the messages received from the network server are positive, and disallowing access to the data if a negative message is received from the network server. Among other things, this embodiment allows the network server to prevent unauthorized access to data stored on the portable device even if an unauthorized user obtains the password as well as the portable device.

In another embodiment of the invention, the portable device encrypts the data before sending it to the host computer, and if the network server is provided with the correct password, then the corresponding decryption key is sent from the network server to the host computer, thus allowing the host computer to decrypt the encrypted data. Among other things, this later embodiment provides improved security because the password is stored on the network server and the network server has control over each request of the host computer for decrypting the encrypted data.

### BRIEF DESCRIPTION OF THE SEVERAL VIEWS OF THE DRAWING

The above and other features, objects and advantages of the invention will be better understood by referring to the following detailed description in conjunction with the accompanying drawing in which:

FIG. 1 is a schematic diagram of the interaction of a portable device, a host computer, and a network server, in accordance with the present invention.

FIG. 2 is an exemplary embodiment of a portable device.

FIG. 3 is an exemplary schematic block diagram of an embodiment of a portable device with secure storage.

FIG. 4 is a flow diagram showing a method for allowing or disallowing host computer access to data stored on a portable device in accordance with the present invention.

FIG. 5 is a flow diagram showing another procedure for allowing or disallowing host computer access to data stored on a portable device in accordance with the present invention.

### DETAILED DESCRIPTION OF THE INVENTION

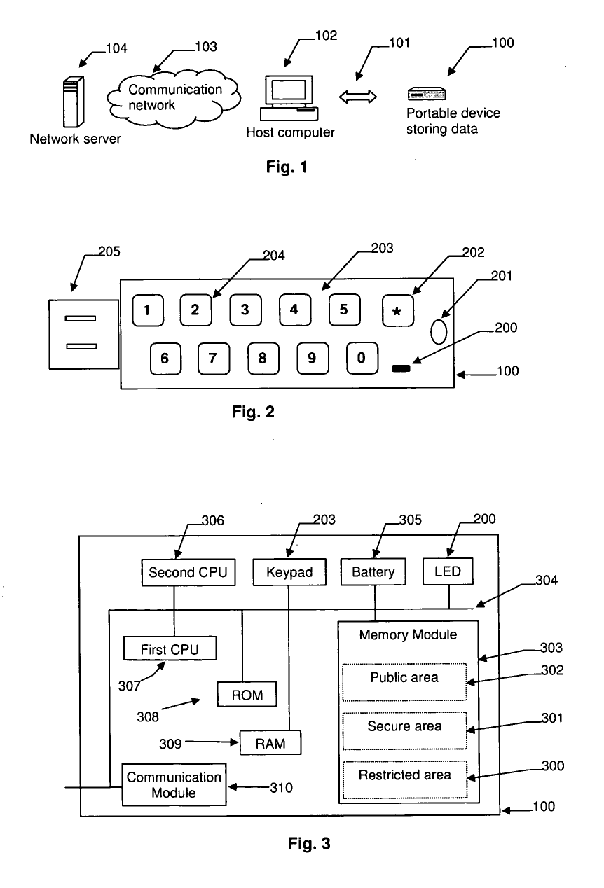

FIG. 1 illustrates a portable device 100, a host computer 102, and a network server 104. A portable device 100 is any electrical circuit configured with logic to store information and communicate with a computer (e.g., a Flash drive or a media player). Although the host computer 102 is shown in FIG. 1 as a PC (personal computer), a host computer is any electrical circuit equipped with logic to communicate with portable devices and network computers. Connection 101, which can be wired or wireless (e.g., USB, SD, MMC, Compact Flash, Firewire, Ethernet, IEEE 802.11 standards, and Bluetooth), allows the portable device 100 and the host computer 102 to exchange information. The host computer 102 has a wired (e.g., Ethernet cable) or wireless (e.g., IEEE 802.11 standard) connection with the communications network 103. Examples of communications network include a local area network (LAN), a wide area network (WAN), a virtual private network (VPN), and the Internet in particular. The network server 104 is also connected to the communications network 103. The portable device 100 is registered with the network server 104. The communication on connection 101 can be encrypted or not. The communication on connection 103 can be encrypted or not. Connection 103 may be unavailable due to network unavailability or dysfunction. The portable device 100 and the network server 104 may share cryptographic keys (not shown) for implementing cryptographic algorithms.

Although the schematics of FIG. 1 describe a simple configuration in which a single portable device 100 is registered with a single network server 104, the description and concepts equally apply to other configurations differing from FIG. 1, such as a configuration where a plurality of portable devices is registered with a single network server or a plurality of network servers.

FIG. 2 is an exemplary portable device 100. The housing of the portable device 100 is coupled to a USB connector 205. Preferably, a potting and encapsulating material (not shown) covers some of the electrical circuitry (not shown) inside the portable device 100 to protect the circuitry from physical access or damage. A hole 201 in the housing can be used for attaching the portable device 100 to, for example, a key chain. The device can be turned on and off by pressing key 202 and holding it down for a few seconds. A light emitting diode (LED) 200 can be used to indicate, for example, that the device has been turned on. The portable device 100 may comprise a keypad 203 with numerical keys 204 for accepting user input. The keypad may have a different number of keys, and the keys may have a different arrangement or different symbols. The portable device may comprise a biometric data sensor (e.g., fingerprint scanner), a trackball, a dial, or a touchpad for accepting user input. The device can be configured to automatically erase all previously provided user input if connection 101 is terminated. The status of the portable device may be given to the user using multiple LEDs, a display (e.g., a Liquid Crystal Display), or a speaker.

In one embodiment of the invention the password is stored in the portable device 100. The portable device 100 may comprise, for example, an LED for indicating that the input equals the password. However, in the preferred embodiment no such indication is given. Preferably, no such indication should be given at least until power is provided to the portable device through connection 101, and this improves the security of the portable device because, for example, in a scenario where all password attempts have failed, the power supplied through connection 101 enables the portable device to erase some of the data it stores. In another embodiment of the invention the password is stored on the network server 104, but not on the portable device 100. In all embodiments, an encryption or a hashed value of the password can be stored instead of storing the password itself.

FIG. 3 is an exemplary schematic block diagram of the embodiment of a portable device with secure storage. The portable device comprises a first Central Processing Unit (CPU) 307 for encryption and data storage management, a communication module 310 (e.g., USB or Bluetooth) for communicating with a host computer 102, a Read Only Memory (ROM) 308 and a Random Access Memory (RAM) 309 that the first CPU may use in its computations, a memory module 303 (e.g., Flash memory, hard drive, etc.), a second CPU 306 for accepting keypad input and managing battery charging, a keypad 203, a battery 305, and an LED 200. The first CPU 307, the ROM 308, the RAM 309, the communication module 310, the memory module 303, the second CPU 306, the keypad 203, the battery 305, and the LED 200 are connected to each other by way of a bus 304. In this embodiment, the memory unit 303 is logically partitioned into at least three areas: a public area 302 that can be accessed by any user, a secure area 301 that can be accessed only by an authorized user, and a restricted area 300 that can be accessed only by the first CPU 307. In other embodiments, a subset of these areas may be provided. The size of the public area 302 and the size of the secure area 301 can be set by the user, and the memory module can be configured to have a plurality of public or secure partitions. Among other things, the restricted area can be used for storing status information, cryptographic keys, cryptographic algorithms, passwords, and any information for user authentication.

In the preferred embodiment, a battery 305 provides power to at least the second processor 306, the keypad 203, and the LED 200, thus allowing user input to be provided regardless of whether the portable device receives power through connection 101 or not. The portable device 100 may use a chargeable battery, a non-chargeable battery, or a capacitor as a source of power, and charging the source of power can be done using power supplied through connection 101. In another embodiment, the portable device 100 may not have its own power source, and power is supplied through connection 101.

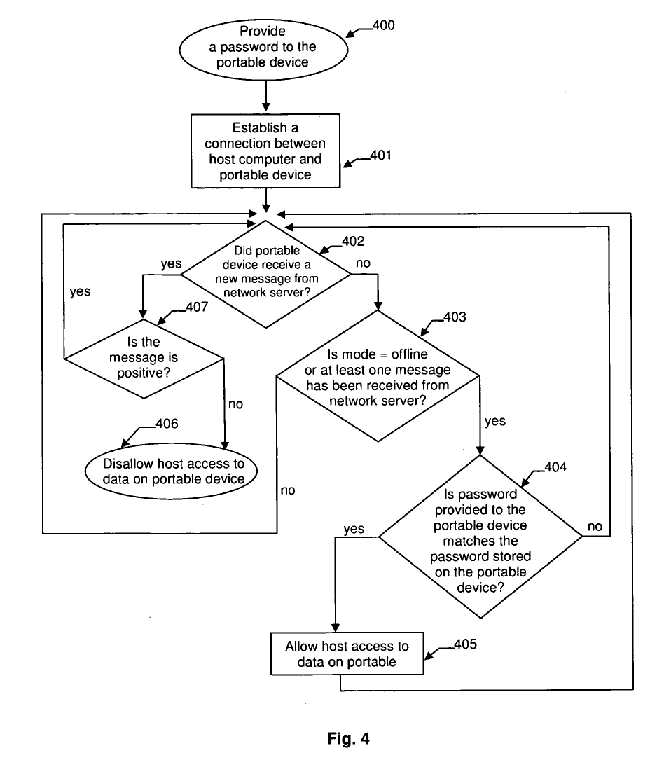

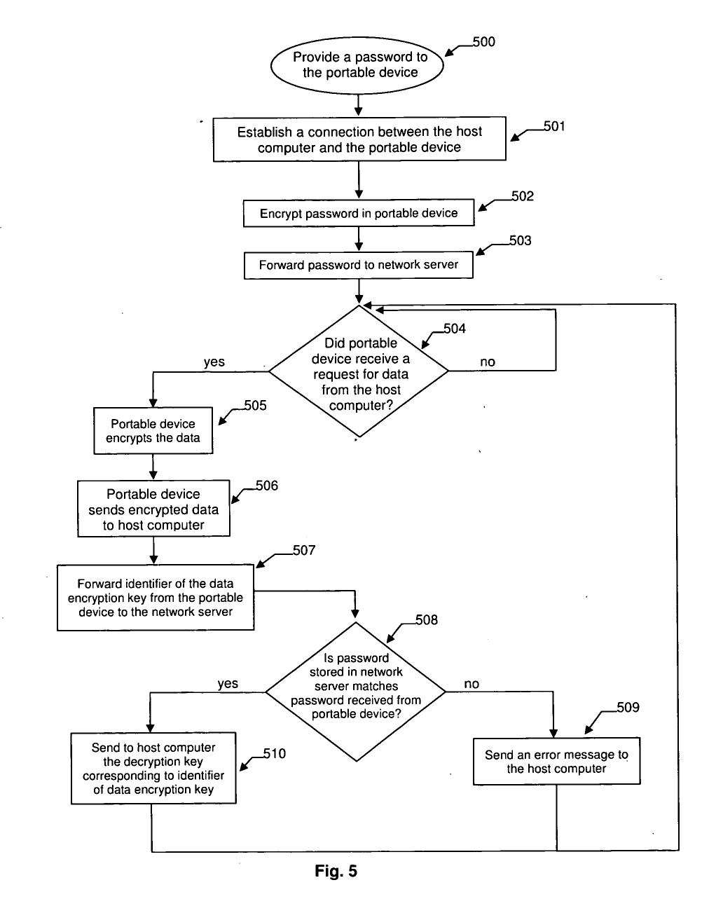

FIG. 4 is a flow diagram showing a method for allowing or disallowing host computer 102 access to data stored on a portable device 100. The flow diagram of FIG. 4 can be applied to any portable device, and in particular to the exemplary portable device with secure storage depicted in FIG. 3.

A password is provided 400 to the portable device, and connection 101 is established 401 between the portable device 100 and the host computer 102. In the preferred embodiment the password is given directly to the portable device 100 by way of the keypad 203. In other embodiments the password may be given to the host computer 102 and provided 400 to the portable device 100 after establishing 401 connection 101.

Messages from the network server 104 are forwarded (not shown) by the host computer 102 to the portable device 100. The portable device has an operation mode that can be set only after the correct password has been provided, the mode can take at least two values: online, and offline. In the online mode access to the data is disallowed if the portable device received no messages from the network server. If the portable device receives 402 a new message from the network server, then it checks 407 whether the message is positive or negative. If the message is negative, meaning that the server disallows access to the data, then the portable device disallows 406 access to the data. If the portable device did not receive a new message, then it checks 403 if the operation mode is set to be offline or at least one message has been received from the network server 104. If the check 403 is true, then the portable device checks 404 whether the password provided to it matches the password stored on the portable device 100, and if this is true, then the portable device allows 405 host computer 102 access to the data on the portable device 100. The offline operation mode is less secure. In the offline mode, even if no messages have been received from the network server 104, then the portable device 100 allows 405 access to the data as long as the password provided matches 404 the password stored on the portable device 100, and no negative message 407 is received 402 from the network server 104.

In another embodiment of the invention the portable device 100 allows only a finite number (for example, 10) of passwords to be provided, and if all passwords provided did not match the stored password, then the portable device may lock itself such that the only way to unlock it is, for example, through a website interface. The portable device 100 may record the history of its interaction with the host computer 102 and the user. If the connection 101 between the host computer 102 and the portable device 100 is malfunctioning or inactive, then the portable device may erase the password provided to it.

Although the flow diagram of FIG. 4 describes a method for allowing or disallowing host computer 102 access to data stored on any portable device, the description and concepts equally apply to configurations differing from FIG. 4, such as a configuration where the portable device has a memory module with multiple partitions (for example, the memory module 303 described in FIG. 3) and the method described in the flow diagram of FIG. 4 is applied only to certain data areas in said memory module (for example, the Secure area 301 described in FIG. 3).

FIG. 5 is a flow diagram showing another procedure for allowing or disallowing host computer 102 access to data stored on a portable device 100. The flow diagram of FIG. 5 can be applied to any portable device, and in particular to the exemplary portable device with secure storage depicted in FIG. 3.

A password is provided 500 to the portable device, and connection 101 is established 501 between the portable device 100 and the host computer 102. In the preferred embodiment the password is given directly to the portable device 100 by way of the keypad 203. In other embodiments the password may be given to the host computer 102 and provided 500 to the portable device 100 after establishing 501 connection 101.

The portable device encrypts 502 the password, and the encrypted password is forwarded 503 from the portable device 100 to the network server 104. The portable device checks 504 if a request for data was made by the host computer 102, and if this is true, then the portable device encrypts 505 the data, sends 506 the encrypted data to the host computer 102, and sends 507 the identifier of the corresponding encryption key to the network server 104. The network server compares 508 the password it stores with the password received from the portable device 100. If the passwords do not match, then the network server 104 sends 509 an error message to the host computer 102. If the passwords match, then the network server 104 sends 510 to the host computer 102 the decryption key corresponding to the identifier of the data encryption key. This allows the host computer 102 to decrypt the data (not shown).

1. A portable device equipped with a memory module for storing data and a keypad for receiving user input, said portable device comprising:
circuitry configured with logic to operate the memory module, receive signals from the keypad, and communicate with a computer by way of a communication module, the circuitry configured to automatically erase all previously provided user input if the connection with said computer has terminated;

2. A portable device according to claim 1, wherein said circuitry is encapsulated in potting material covering at least part of said circuitry and said circuitry is further equipped with a battery allowing the keypad to be operated even if said portable device is not physically connected to a computer.

3. A portable device according to claim 2, wherein said circuitry is further equipped with a USB connector for communicating with a host computer and a liquid crystal display (LCD) for displaying information to the user, both are connected to the circuitry by way of a bus.

4. A portable device according to claim 1, wherein said circuitry is further configured to store data in logical partitions and said memory module has at least three partitions:
a public partition for storing data that can be accessed by any computer;
an encrypted partition that can be accessed only by authorized users; and
an encrypted partition that can be accessed only by said circuitry.

5. A method for enabling or disabling host computer access to data stored in a portable device using a network server and a password, the portable device stores an encryption of the password and is registered with a network server, the host computer incorporating circuitry for communicating with the portable device, the method comprising the steps of:
providing a password to the portable device;
establishing a connection between the host computer and the portable device;
forwarding messages from the network server to the portable device;
disallowing host computer access to the data stored on the portable device if at any given time the portable device received a negative message from the network server;
checking if the operation mode is set to be offline or at least one message has been received from the network server; and
allowing host computer access to the data if said checking is true and the encryption of the password provided equals the encrypted password stored on the portable device.

6. The method of claim 5, wherein after connection between the host computer and the portable device is established the host computer can unconditionally access at least one partition on said memory module.

7. The method of claim 5, wherein the portable device and the network server share cryptographic keys for message encryption, message integrity, and message authentication and the method further comprising a step of destructing the data on the portable device if a destructive message is received from the network server.

8. The method of claim 5, wherein the communication between the host computer and the portable device is wireless.

9. A method for enabling or disabling host computer access to data stored in a portable device using a network server and a password, the portable device is registered with a network server, the host computer incorporating circuitry for communicating with the portable device, the method comprising the steps of:
providing a user password to the portable device;
establishing a connection between the host computer and the portable device;
encrypting the password in the portable device;
forwarding the encrypted password to the network server;
receiving, at the portable device, a request for data from the host computer;
encrypting the data in the portable device;
sending the encrypted data from the portable device to the host computer;
forwarding the identifier of the data encryption key from the portable device to the network server;
comparing the encrypted password stored in the network server with the encrypted password received from the portable device; and
sending from the network server to the host computer an error message if the passwords do not match, and a decryption key corresponding to the identifier of the data encryption key if the passwords match.

10. The method of claim 9, wherein providing a user password to the portable device takes place after establishing a connection between the host computer and the portable device and the password is provided to the portable device or through the host computer.

11. The method of claim 9, wherein the host computer can unconditionally access at least one partition on said memory module after connection between the host computer and the portable device is established.

12. The method of claim 9, further comprising the step of decrypting the encrypted data received by the host computer using the decryption key received from the network server.

13. The method of claim 9, further comprising a step of destructing the data on the portable device if a destructive message is received from the network server.

14. The method of claim 9, further comprising a mode of operation allowing the portable device to send unencrypted data directly to the host computer.

15. The method of claim 9, wherein the portable device and the network server share cryptographic keys for message encryption, message integrity, and message authentication.

16. The method of claim 9, wherein the communication between the host computer and the network server is encrypted.

17. The method of claim 9, wherein the communication between the host computer and the portable device is encrypted.

18. The method of claim 9, wherein the communication between the host computer and the portable device is wireless.

19. A method for allowing or disallowing access to data stored on a portable device comprising: allowing access to said data if a correct password is provided to said portable device and no negative message has been received from a network server.
